(19) United States
(12) Patent Application Publication
(10) Pub. No.: US 2026/0259155 A1
(43) Pub. Date: Sep. 3, 2026

(54) SAMPLE MEASUREMENT DEVICE

(71) Applicant: Hitachi High-Tech Corporation, Minato-ku, Tokyo (JP)

(72) Inventors: Yasuhiro SHIRASAKI, Tokyo (JP); Minami UCHIHO, Tokyo (JP); Daisuke BIZEN, Tokyo (JP); Makoto SAKAKIBARA, Tokyo (JP)

(21) Appl. No.: 18/873,015

(22) PCT Filed: Aug. 5, 2022
(86) PCT No.: PCT/JP2022/030067

§ 371 Date: Dec. 9, 2024

(51) Int. Cl. G01N 23/2251

(52) U.S. Cl. CPC G01N 23/2251; G01N 2223/303

(57) ABSTRACT

A sample measurement device includes: a light source configured to irradiate a sample including an insulating film with light; an excitation source configured to irradiate the sample with a primary beam to emit a charged particle; a detector configured to apply at least one of an electric field or a magnetic field to the charged particle to separate a trajectory according to energy of the charged particle, thereby outputting a detection signal depending on the energy of the charged particle; and a control device configured to process a detection signal of the charged particle obtained from the detector. The control device changes a light irradiation condition, and acquires detection signals by the detector under different irradiation conditions, and determines a material characteristic value of the insulating film based on the detection signals under the different irradiation conditions using information indicating a relationship between the detection signal and the material characteristic value, and outputs the material characteristic value.

### TECHNICAL FIELD

The present invention relates to a sample measurement device.

### BACKGROUND ART

In a semiconductor device, a film quality of an insulating film is important. Here, physical properties such as material characteristics including a defect (trap) density, a defect level, band energy, carrier mobility, a carrier lifetime, and a maximum voltage (withstand voltage) that can be applied to an insulating film, of an insulating film or an interface between an insulating film and a semiconductor, are collectively referred to as the film quality. One of insulating films with important film quality is a gate oxide film of a transistor. When many defects exist in the gate oxide film and the film quality is poor, charges are accumulated in the insulating film over time, changing performance of the transistor. That is, reliability of the device is reduced. In a memory device, the insulating film is an important film used as a memory function by holding charges. In this case as well, the film quality of the insulating film determines a function of a memory, such as volatility of the memory. Thus, the film quality of the insulating film, which is important for a device, can be inspected and measured at appropriate times during a semiconductor process to improve yield and reliability of the semiconductor device.

PTL 1 describes a device that uses an electron beam to measure a change in potential on a surface of a semiconductor sample caused by irradiating the sample with light.

### CITATION LIST

### Patent Literature

PTL 1: JP2001-144155A

### SUMMARY OF INVENTION

### Technical Problem

As a method of measuring the film quality, CV measurement for measuring a relationship between capacitance and a voltage when a target insulating film is sandwiched between electrodes is known. However, in the CV measurement, it is necessary to prepare an electrode on the insulating film, which is time-consuming and costly. It is difficult to make the electrode small, and spatial resolution of film quality measurement is limited. There is a demand for a method of inspecting and measuring an insulating film quality with high spatial resolution even immediately after deposition of the insulating film in which a fine semiconductor device is not completed.

The device described in PTL 1 evaluates properties of a semiconductor that is not charged by an electron beam. Since an insulator is charged by an electron beam and physical properties to be evaluated are different, the device in PTL 1 is insufficient.

### Solution to Problem

A sample measurement device according to one aspect of the invention includes: a light source configured to irradiate a sample including an insulating film with light; an excitation source configured to irradiate the sample with a primary beam to emit a charged particle; a detector configured to apply at least one of an electric field or a magnetic field to the charged particle to separate a trajectory according to energy of the charged particle, thereby outputting a detection signal depending on the energy of the charged particle; a control device configured to process a detection signal of the charged particle obtained from the detector; and an input device configured to input information related to the sample from a user, in which the control device determines a change in potential of the sample under different irradiation conditions based on detection signals detected by the detector under the different irradiation conditions of the light and information indicating a relationship between the detection signal and a potential of the sample, and converts the change in potential into a material characteristic value of the insulating film using a film thickness and a dielectric constant in information related to the sample, and outputs the converted material characteristic value.

A sample measurement device according to one aspect of the invention includes: a light source configured to irradiate a sample including an insulating film with light having a plurality of wavelengths; an excitation source configured to irradiate the sample with a primary beam to emit a charged particle; a detector configured to apply at least one of an electric field or a magnetic field to the charged particle to separate a trajectory according to energy of the charged particle, thereby outputting a detection signal depending on the energy of the charged particle; and a control device configured to process a detection signal of the charged particle obtained from the detector, in which the control device generates a comparison signal indicating a comparison result of detection signals detected by the detector under different irradiation conditions of the light, for each of different wavelengths of the light, and outputs information on the film quality of the insulating film based on the comparison signal.

A sample measurement device according to one aspect of the invention includes: a light source configured to irradiate a sample including an insulating film with light; an excitation source configured to irradiate the sample with a primary beam to emit a charged particle; a detector configured to apply at least one of an electric field or a magnetic field to the charged particle to separate a trajectory according to energy of the charged particle, thereby outputting a detection signal depending on the energy of the charged particle; a control device configured to process a detection signal of the charged particle obtained from the detector; and an input device configured to input information related to the sample from a user, in which the control device changes a light irradiation condition, and acquires detection signals by the detector under different irradiation conditions, and determines a material characteristic value of the insulating film based on the detection signals under the different irradiation conditions using information indicating a relationship between the detection signal and the material characteristic value, and outputs the material characteristic value.

### Advantageous Effects of Invention

According to one aspect of the invention, a desired film quality of a sample can be measured.

### BRIEF DESCRIPTION OF DRAWINGS

FIG. 1 schematically shows a schematic configuration example of an SEM.

FIG. 2 shows a hardware configuration example of a control device.

FIG. 3 is a flowchart of an example of control processing of the SEM executed by the control device.

FIG. 4 shows an example of a calibration screen on a setting and measurement screen.

FIG. 5 shows a period during which ultraviolet laser light is emitted from a light source, a change in an EF voltage over time, and a period during which imaging (signal electron detection) is performed.

FIG. 6 shows a detector characteristic.

FIG. 7 schematically shows a relationship between an EF voltage and a detection signal in different charged states of a sample.

FIG. 8 shows a relationship between a detection signal amount of signal electrons and a sample potential calculated as described above.

FIG. 9 shows an example of a setting screen for measuring a film quality of a target sample.

FIG. 10 shows an example of a sequence of laser light irradiation and imaging under a setting condition described with reference to FIG. 9.

FIG. 11 shows an example of a GUI screen for a measurement stage.

FIG. 12 shows another example of a GUI screen for the measurement stage.

FIG. 13 shows a device configuration example of an SEM equipped with a lock-in detection mechanism according to Embodiment 2.

FIG. 14 is a flowchart of an example of control processing of the SEM executed by a control device according to Embodiment 3.

FIG. 15 shows an example of a GUI screen in a measurement stage according to Embodiment 3.

FIG. 16 is a flowchart of an example of control processing of an SEM executed by a control device according to Embodiment 4.

FIG. 17 shows an example of a GUI screen in a measurement stage according to Embodiment 4.

FIG. 18 shows an example of a sequence of laser light irradiation to a sample and imaging of the sample in Embodiment 5.

FIG. 19 shows an example of a sequence of laser light irradiation to a sample and imaging of the sample in Embodiment 5.

FIG. 20 shows an example of a GUI screen in a measurement stage according to Embodiment 5.

### DESCRIPTION OF EMBODIMENTS

Hereinafter, embodiments will be described with reference to the drawings. Throughout the drawings for showing the embodiments, the same elements are denoted by the same reference signs, and the repeated description thereof is omitted. In an example of a device specifically described below, a sample is measured by using an electron beam as a primary beam and detecting signal electrons as signal charged particles. Characteristics of the present disclosure can also be applied to other devices, for example, devices that use an ion beam or laser light as a primary beam and/or detect ions as signal charged particles.

### Embodiment 1

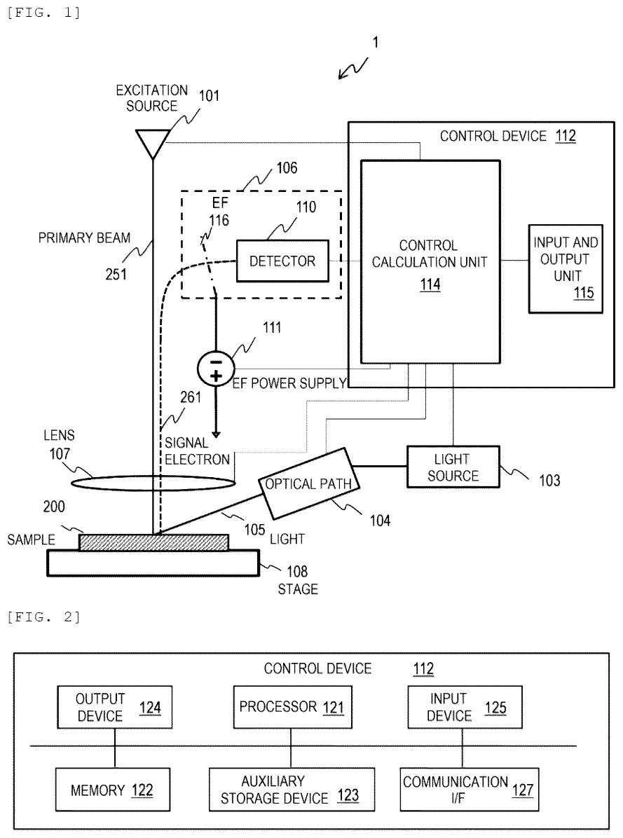

FIG. 1 schematically shows a schematic configuration example of a scanning electron microscope (SEM) 1. The scanning electron microscope 1 is a sample measurement device according to an embodiment of the present description, which measures a material characteristic value of a film quality of a sample, for example, a potential and a withstand voltage of an insulating film. The SEM 1 uses an electron beam to observe and measure a sample.

The SEM 1 shown in FIG. 1 includes an electron optical system and a control device 112 that controls the electron optical system and measures a sample. For ease of description, FIG. 1 shows only some components of the electron optical system. The SEM may include other components not shown, such as other lenses, aligners, stigmators, deflectors, and separators. An optical element (a lens, a deflector, a separator, or the like) of the SEM generates an electric field, a magnetic field, and combined magnetic and electric fields that act on the electron beam.

In the electron optical system, an objective lens 107 is provided on a trajectory of a primary beam 251 extracted from an excitation source 101 toward a sample 200. In this example, the excitation source 101 is (an electron source but other charged particle sources, lasers, and the like may be used as long as the charged particle sources, lasers, and the like are excitation sources that emit signal charged particles).

The primary beam 251 is focused on the sample 200 after passing through the objective lens 107. For example, a scanning deflector (not shown) is provided between the excitation source 101 and the objective lens 107, and controls a direction of the primary beam 251 so that the primary beam 251 two-dimensionally scans a region on the sample 200.

The primary beam 251 emitted on the sample 200 interacts with a substance near a surface, and secondary electrons and other signal electrons are generated depending on a shape and material of the sample. In the present embodiment, the secondary electrons emitted from the sample 200 and detected by the detector 110 are referred to as signal electrons.

The sample 200 is provided on a stage 108. The primary beam 251 emitted on the sample 200 interacts with a substance near the surface of the sample 200 to generate signal electrons 261. A negative voltage is applied to the stage 108, and an electric field is generated on the sample 200. This electric field causes the signal electrons 261 to travel back along the trajectory of the primary beam 251. A beam separator (not shown) deflects the signal electrons 261 to separate a trajectory from the trajectory of the primary beam 251.

The detector 110 detects the signal electrons 261 and converts the signal electrons 261 into a detection signal. An intensity of the detection signal changes depending on the shape and material of the sample 200 at a position irradiated with the primary beam 251.

An energy filter (EF) 116 is provided in front of the detector 110. The energy filter 116 and the detector 110 constitute an energy detector 106. The signal electrons 261 from the sample 200 pass through the energy filter 116 and enter the detector 110. The detector 110 detects the signal electrons 261 that pass through the energy filter 116. The energy filter 116 is connected to an EF power supply 111. The EF power supply 111 provides a voltage set by the control device 112 to the energy filter 116.

The energy filter 116 includes, for example, a metal mesh and is applied with a voltage from the EF power supply 111. The energy filter 116 repels or passes the signal electrons 261 according to the applied EF voltage. Thus, the energy filter 116 separates the trajectory according to energy of the signal electrons 261.

The energy filter 116 separates the trajectory of the signal electrons 261 according to energy using an electric field. An energy filter according to another example may separate the trajectory of the signal electrons 261 according to energy using a magnetic field. The energy filter may be a spectrometer that does not reflect the signal electron but deflects the signal electron at different angles according to energy, separating the trajectory of the signal electron. The energy detector can output a detection signal depending on the energy of the signal electron by applying at least one of an electric field or a magnetic field to the signal electron and separating the trajectory of the signal electron according to the energy of the signal electron.

The control device 112 sweeps an EF voltage, and determines an EF voltage at which the signal electrons 261 become undetectable or detectable by the detector 110. The EF voltage, which indicates whether the signal electrons 261 are detected, corresponds to the energy of the signal electrons 261, and the energy of the signal electrons 261 is associated with a potential of the sample 200.

Since the sample 200 contains an insulator, the sample 200 is charged by irradiation with the primary beam 251. For example, it is assumed that the sample 200 is positively charged. When the potential of the sample 200 is high, the energy of the detected signal electrons 261 decreases. For example, when the sample 200 is in an uncharged state and the energy of the signal electrons 261 is 1 kV, and when the sample 200 is in a positively charged state, the signal electrons 261 can have a kinetic energy of 990 V.

The detector 110 measures a signal electron energy. As will be described later, the potential of the sample 200 and the film quality of the sample based thereon are measured based on a measurement result of the signal electron energy by the detector 110. The film quality to be measured is, for example, a defect density [pieces/cm²], carrier mobility [cm²/(Vs)], a defect level [eV], and band energy [eV] in an insulating film or at an interface. A defect in the insulating film is not a shape defect but a material defect such as a trap.

For more accurate measurement, it is important to know the signal electron energy in an uncharged state of the sample 200. The SEM 1 according to the embodiment of the present description irradiates the sample 200 with light 105 from a light source 103 to remove charge from the sample 200. The control device 112 controls the light source 103 and/or an optical path 104, and irradiates the sample 200 with the light 105 via the optical path 104. The light 105 is, for example, ultraviolet light, and a wavelength thereof may be, for example, 400 nm or less. The light source 103 is, for example, an ultraviolet light laser. The light source 103 may be obtained by monochromatizing a white light source with a monochromator. The light source 103 includes a plurality of light sources, and may be configured to select a light source according to wavelength setting.

For example, the control device 112 measures a relationship between the EF voltage and the signal electron energy while irradiating the sample 200 with the ultraviolet light 105 from the light source 103. Accordingly, the energy of the signal electrons 261 when the charge amount of the sample 200 is 0 V is determined. Thereafter, the control device 112 keeps the light 105 in the light source 103 and the optical path 104 OFF, and measures the relationship between the EF voltage and the signal electron energy. Based on the two measurement results, a charge amount [V] of the sample 200 when the sample 200 is irradiated with the primary beam 251 is determined.

All the above components of the electron optical system for measurement are controlled by the control device 112. In the configuration example in FIG. 1, the control device 112 includes a control calculation unit 114 and an input and output unit 115. The control calculation unit 114 controls the component, calculates a signal electron intensity detected by the detector 110, and generates desired information. When the input and output unit 115 receives a setting operation by a user and presents requested information to the user.

FIG. 2 shows a hardware structure example of the control device 112. The control device 112 can have a computer configuration. The control device 112 includes a processor 121, a memory (main storage device) 122, an auxiliary storage device 123, an output device 124, an input device 125, and a communication interface (I/F) 127. These components are connected to each other by a bus. The memory 122, the auxiliary storage device 123, and a combination thereof are storage devices, and store programs and data used by the processor 121.

The memory 122 is implemented by, for example, a semiconductor memory, and is mainly used to hold a program and data currently being executed. The processor 121 executes various types of processing in accordance with programs stored in the memory 122. Various functional units are implemented by the processor 121 operating according to a program. The auxiliary storage device 123 is implemented by, for example, a large-capacity storage device such as a hard disk drive or a solid state drive, and is used to hold programs and data for a long period.

The processor 121 may be implemented by a single processing unit or a plurality of processing units, and may include a single or a plurality of calculation units or a plurality of processing cores. The processor 121 can be implemented as one or more central processing units, microprocessors, microcomputers, microcontrollers, digital signal processors, state machines, logic circuits, graphics processing devices, chip-on-systems, and/or any device for operating a signal based on a control instruction. Functional units of the control device 112, for example, the control calculation unit 114 and the input and output unit 115 may be implemented by the processor 121 operating together with other devices according to a program. For example, the input and output unit 115 may be implemented by the processor 121 operating in both the output device 124 and the input device 125.

A program and data stored in the auxiliary storage device 123 are loaded into the memory 122 at the time of start-up or when necessary, and the program is executed by the processor 121, thereby causing the control device 112 to execute various types of processing. Therefore, the processing executed by the control device 112 in the following is processing executed by the processor 121 or a program.

The input device 125 is a hardware device for a user to input an instruction, information, and the like to the control device 112. The output device 124 is a hardware device that presents various images for input and output, for example, a display device or a printing device. The communication I/F 127 is an interface for connection to a network.

A function of the control device 112 can be implemented in a computer system including one or more computers, including e or more processors and one or more storage devices, one including a non-transitory storage medium. The plurality of computers communicate with each other via a network. For example, a part of a plurality of functions of the control device 112 may be implemented in one computer, and another part may be implemented in another computer.

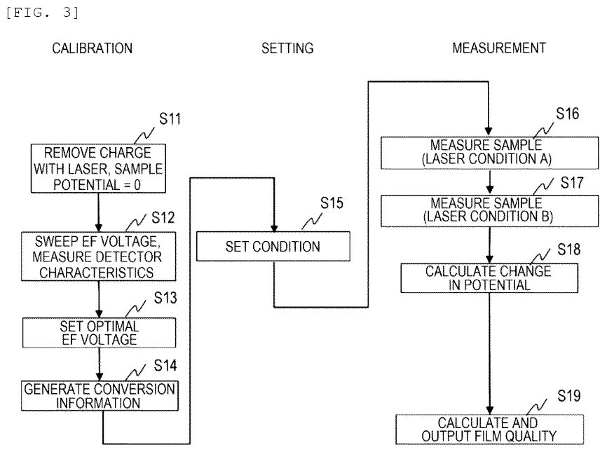

FIG. 3 is a flowchart of an example of control processing of the SEM 1 executed by the control device 112. FIG. 3 shows a flow for measuring the film quality, for example, material characteristic values such as a charge amount and a withstand voltage of the insulating film. A control flow includes three stages, a calibration stage, a setting stage, and a measurement stage. The calibration stage includes steps S11 to S14, the setting stage includes step S15, and the measurement stage includes steps S16 to S19.

In the calibration stage, the detector 110 and the EF voltage are calibrated. The control device 112 periodically performs the calibration stage to enable more accurate measurement of a sample potential of a target sample. First, in step S11, the control device 112 irradiates the sample 200 with the light 105 from the light source 103 via the optical path 104. Here, it is assumed that the light source 103 is a laser having a wavelength capable of removing charge when the sample 200 is charged, for example, an ultraviolet laser. The charge of the sample 200 is removed by ultraviolet laser light 105, and a charge amount becomes 0 V.

Next, in step S12, the control device 112 measures energy characteristics of the signal electrons 261 from the sample to measure detector characteristics indicating a relationship between a setting condition of the detector and an intensity of signal electron detection signal. The control device 112 sweeps (increases or decreases) an EF voltage applied to the energy filter 116 while the sample 200 is irradiated with the ultraviolet laser light 105. The control device 112 irradiates the sample 200 with a primary electron beam at different EF voltages, and measures a detection signal amount of the signal electrons 261 by the detector 110. A role of the irradiation with the ultraviolet laser light 105 in step S11 is to measure the detector characteristics in step S12 when the sample is not charged, that is, when the charge amount is 0 V. If a similar effect can be obtained, the ultraviolet laser light 105 may be emitted onto the sample 200 in step S11 before EF voltage sweep, constantly during the EF voltage sweep, or periodically during the EF voltage sweep.

In measuring energy characteristics of the signal electrons 261, the primary beam 251 may or may not be used to scan (move) two-dimensionally as long as the primary beam 251 is used to irradiate a region of the sample 200 having the same material and thickness. A detected intensity of the signal electrons 261 depends on the EF voltage and a configuration of the sample 200, but an SEM 1 optical system is not dependent on a primary beam irradiation position.

Next, in step S13, the control device 112 sets an optimal EF voltage for sample measurement based on a measurement result in step S12. The control device 112 can change the EF voltage as described above to determine sensitivity of a detection signal of the signal electrons 261 to the EF voltage as the optimal EF voltage. Alternatively, an EF voltage designated by a user may be set as the optimal EF voltage by referring to the measurement result.

Next, in step S14, the control device 112 generates conversion information for converting a detection signal amount of the signal electrons from the measurement target sample into a sample potential of a measurement target sample, and stores the conversion information in the auxiliary storage device 123. The sample potential depends on a stage voltage and a charge amount of the sample 200. In the measurement of the sample, signal electrons from the sample are measured while the optimal voltage determined in step S13 is applied to the energy filter 116. In measurement of a target sample, the sample potential is calculated based on the detection signal amount of the detector 110 by referring to the conversion information. The conversion information can be represented in any format such as a mathematical formula or a lookup table.

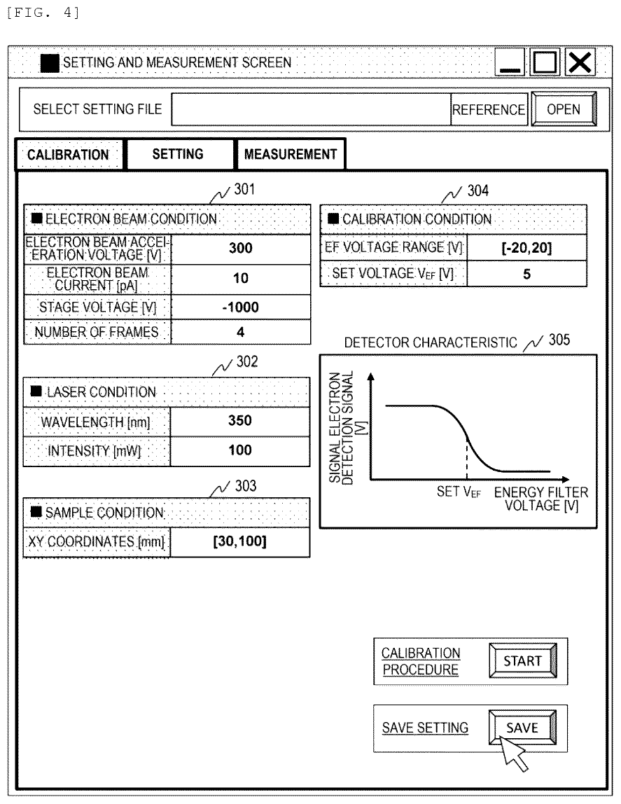

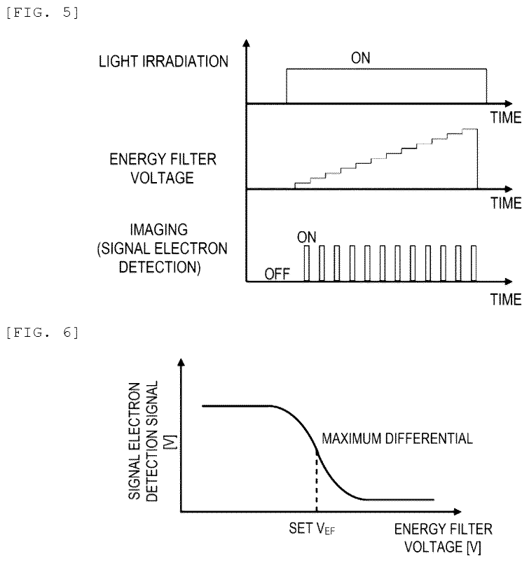

Here, details of steps S11 to S14 will be described. FIG. 4 shows an example of a calibration screen on a setting and measurement screen. The user can input an electron beam condition 301, a laser condition 302, a sample condition 303, and a calibration condition 304 within the calibration screen.

The user can set an electron beam acceleration voltage, an electron beam current, a stage voltage, and the number of frames as the electron beam condition 301 for calibration. The electron beam is the primary beam 251. The stage voltage is a voltage applied to the sample stage 108.

The number of frames is a value indicating the number of frames used to generate an image of the sample, but if an output of the SEM 1 is not an image, the condition may be an irradiation time of the primary beam 251 or the like. Here, the control device 112 two-dimensionally scans a target region of the sample 200 with the primary beam 251 to generate an image. For example, a mean of four frames is an image of the sample. The detection signal amount may be, for example, a sum or mean of the signal amounts of pixels of the image.

The laser condition 302 indicates conditions of the light source 103 and the optical path 104. In this example, a wavelength and an intensity of the laser light can be set with as laser condition 302. The sample condition 303 indicates coordinates at which the sample to be measured for calibration is provided.

The calibration condition 304 indicates a range of the EF voltage applied to the energy filter 116 and a set voltage V_{EF} used in measurement of the sample potential. The set voltage V_{EF} is a final EF voltage obtained as a result of the calibration. The user can set a sweep range of the EF voltage, and the set voltage V_{EF} is calculated and set by the control device 112. The set voltage V_{EF} may be input to the user in accordance with a measurement result in calibration.

The user sets the electron beam condition 301, the laser condition 302, the sample condition 303, and the EF voltage range in the calibration condition 304 on the calibration screen. When a calibration procedure button is selected by the user, the control device 112 executes steps S11 to S14 in the flowchart in FIG. 3.

The control device 112 displays a detector characteristic 305 obtained by the measurement on the calibration screen. In a graph of the detector characteristic 305, a horizontal axis represents an EF voltage, and a vertical axis represents a detection signal amount of signal electrons. In a specific range of EF voltage, the detection signal amount significantly decreases (increases) as the EF voltage increases (decreases).

The control device 112 can determine the set voltage V_{EF} based on the graph of the detector characteristic 305. A method of determining the determined set voltage V_{EF} will be described in detail later. The set voltage V_{EF} may be designated by the user. The user refers to the detector characteristic 305 and sets an EF voltage value that the user considers appropriate in a cell of the set voltage V_{EF} of the calibration condition 304.

When the user selects a save setting button, the set voltage V_{EF} and other conditions 301 to 304 and the measurement result 305 of the detector characteristic are saved in the auxiliary storage device 123. At least some information other than the set voltage V_{EF} may be excluded from the saved information.

Next, an example of a method of measuring a calibration sample for calibrating the detector and the EF voltage in step S12 will be described. FIG. 5 shows a period during which ultraviolet laser light is emitted from the light source 103, a change in an EF voltage over time, and a period during which imaging (signal electron detection) is performed. In three graphs in FIG. 5, a horizontal axis represents time. In the present description, both acquiring an image when scanning with a primary beam and acquiring signal electrons when the primary beam is kept at a single point are also referred to as imaging.

During the measurement, the control device 112 continuously irradiates the sample 200 with ultraviolet laser light. That is, during the measurement, the light source 103 is kept ON. The control device 112 sweeps the EF voltage from a low value to a high value while irradiating the sample 200 with the laser light. As shown in FIG. 5, the EF voltage is increased stepwise.

In each period in which the EF voltage is constant, the control device 112 acquires an image of the sample 200. That is, the control device 112 scans a specific range on the sample 200 with the primary beam 251 to acquire an image of the sample 200. As described above, the control device 112 images a predetermined number of frames at each EF voltage value, and generates an image based on a mean value thereof. The control device 112 may determine a sum or an mean value of signal amounts (brightness) of pixels of the generated image as the detection signal amount of the signal electrons at the EF voltage. The irradiation with the ultraviolet laser light may not be always ON as in the present embodiment. When detection accuracy of signal electrons is deteriorated by irradiation with ultraviolet laser light, such as generation of photoelectrons, it is effective to turn off the ultraviolet laser light in synchronization with an ON timing of imaging.

Next, an example of a method of determining the set voltage V_{EF} based on a positioning result in step S13 will be described. FIG. 6 shows the detector characteristic. The detector characteristic is represented by a relationship between an EF voltage and a detection signal amount of signal electrons. A horizontal axis represents the EF voltage, and a vertical axis represents the detection signal amount of the signal electrons.

The detection signal amount greatly changes within a specific EF voltage range. Specifically, the detection signal amount is approximately constant as the EF voltage increases from the lowest start voltage up to a specific EF voltage, but starts to decrease significantly at that specific voltage. The detection signal amount continues to decrease from that specific EF voltage as the EF voltage increases up to a specific EF voltage, and then remains approximately constant even if the EF voltage increases.

The set voltage V_{EF} may be set to, for example, an EF voltage value at which an absolute value of a rate of change (differential) of the detection signal amount is the largest.

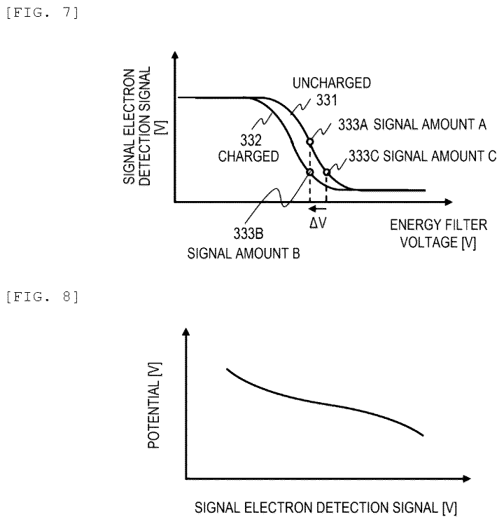

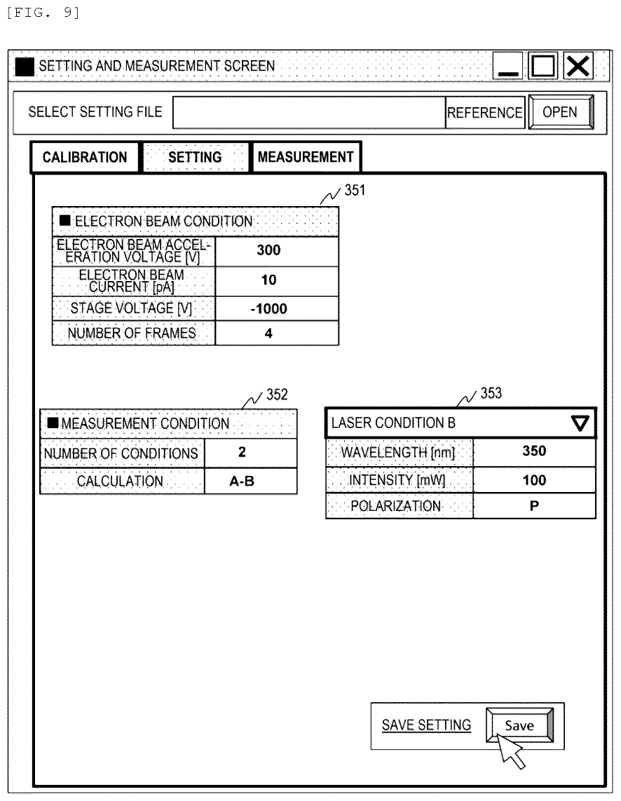

Next, an example of a method of generating the conversion information in step S14 will be described. FIG. 7 schematically shows a relationship between an EF voltage and a detection signal in different charged states of the sample. In a graph in FIG. 7, a horizontal axis represents an EF voltage, and a vertical axis represents a detection signal amount of signal electrons. A line 331 indicates a detection signal amount for the uncharged sample, and a line 332 indicates a detection signal amount for the charged sample.

The uncharged sample corresponds to a sample measured while being irradiated with laser light for calibration. The charged sample corresponds to a measurement target sample. When the charged sample is positively charged, the detection signal amount starts to decrease at an EF voltage lower than a detection signal amount for the uncharged sample.

In the detection signal amount 331 for the uncharged sample, the point 333A indicates an absolute value of the largest differential. A point 333B is a point having the same EF voltage as the point 333A in the detection signal amount 332 for the charged sample. A detection signal amount at the point 333B is smaller than a detection signal amount at the point 333A. A point 333C is a point having the same detection signal amount as the point 333B in the detection signal amount 331 for the uncharged sample. An EF voltage at the point 333C is larger than an EF voltage at the point 333B.

Here, an EF voltage at the point 333A is set to the set voltage V_{EF} at the time of sample measurement. An EF voltage difference ΔV between the point 333C and the point 333B indicates a potential difference between the charged sample and the uncharged sample. A difference between the set voltage V_{EF} and an EF voltage of the uncharged sample at the detection signal amount for the measurement target sample is a potential difference between the measurement target sample and the uncharged sample. The potential difference from a sample potential of the uncharged sample indicates a charge amount of the measurement sample.

FIG. 8 shows a relationship between the detection signal amount of the signal electrons and the sample potential calculated as described above. As shown in FIG. 8, a sample potential of the measurement target sample is represented by a function of the detection signal amount.

Sample potential [V]=f(signal electron detection signal amount)

The control device 112 configures conversion information that defines the function shown in FIG. 8 based on the stage voltage and the relationship 331 between the EF voltage and the signal electron detection signal amount for the uncharged sample, which is measured at the calibration stage. The conversion information is information for converting a measurement result (detection signal amount) of signal electrons of the sample into a sample potential, and can be expressed by a lookup table, a mathematical formula, or the like.

Next, the setting stage in the flowchart in FIG. 3 will be described. The setting stage is implemented by step S15. In step S15, the control device 112 sets a measurement condition of the target sample.

FIG. 9 shows an example of a setting screen for measuring a film quality of the target sample. The user can set an electron beam condition 351, a measurement condition 352, and one or more laser conditions 353 corresponding to the measurement condition 352. The electron beam condition 351 designates a primary electron beam, a stage voltage, and the number of frames similarly to the electron beam condition 301 in the calibration stage.

The measurement condition 352 designates the number of measurement conditions of the sample and a calculation method for a measurement result of the sample. The user can designate a plurality of measurements under different conditions for one sample. In the example shown in FIG. 9, two measurement conditions A and B are designated, and a designated calculation method calculates a difference between the two measurement results.

In the example in FIG. 9, the user can designate a condition of laser light for irradiating the sample. As described above, the laser light changes the potential of the sample. The light source used for sample measurement may be the same or different from the laser used in the calibration stage. The emitted light may not be laser light. As the emitted light, a white light source such as a xenon lamp may be monochromatized using a monochromator.

FIG. 9 shows a laser condition for a measurement condition B (laser condition B) as an example. The laser condition designates a wavelength, intensity, and polarization. In this example, conditions for measuring a charge amount of an insulating film deposited on a semiconductor are shown. The laser condition A designates laser light having an intensity of 0, that is, no irradiation with the laser light. The laser condition B designates irradiation with laser light having a wavelength of 350 nm, an intensity of 100 mW, and a P-polarized light. When the user selects a save setting button, the designated condition is saved in the auxiliary storage device 123.

In another example of the two different measurement conditions A and B, the measurement conditions A and B involve irradiation with laser light having different wavelengths. For example, the laser condition A involves irradiation with laser light having 700 nm, and the laser condition B involves irradiation with laser light having 350 nm. The control device 112 calculates a difference between detection signals of two measurement lines.

As described above, the ultraviolet laser light under the laser condition B acts on the insulating film by using a charge removing effect, but at the same time also acts on the underlying semiconductor, with a photovoltaic voltage and other effects. Energy of the signal electrons to be measured is a combination of effects of a laser on the insulating film and the semiconductor. Since near-infrared laser light under the laser condition A passes through the insulating film, the near-infrared laser light acts only on underlying silicon. That is, when an effect on the semiconductor cannot be ignored, the effect on the semiconductor is subtracted by calculating a difference between measurement results under the laser conditions A and B. Therefore, it is possible to detect an effect on the insulating film alone and appropriately measure the film quality such as the charge amount of the insulating film.

The number of measurement laser conditions designated by the measurement condition 352 is not limited. The calculation method designated by the measurement condition 352 is not limited to subtraction, and any appropriate calculation method can be designated according to the film quality to be calculated.

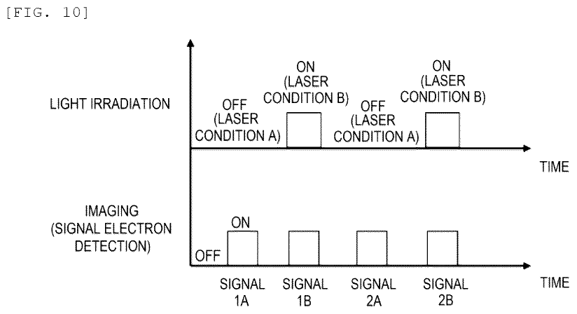

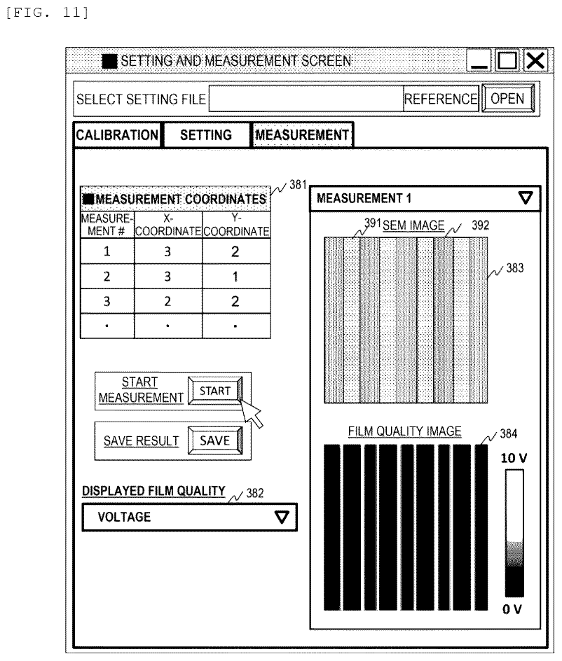

FIG. 10 shows an example of a sequence of laser light irradiation and imaging under a setting condition described with reference to FIG. 9. In the example shown in FIG. 10, the control device 112 captures an image of the sample with the laser turned off (laser condition A), and acquires a signal 1A. Next, the control device 112 captures an image of the sample while irradiating the sample with laser light (laser condition B), and acquires a signal 1B.

Next, the control device 112 captures an image of the sample with the laser turned off (laser condition A), and acquires a signal 2A. Next, the control device 112 captures an image of the sample while irradiating the sample with laser light (laser condition B), and acquires a signal 2B.

For example, the control device 112 may determine a mean value of the signal 1A and the signal 2A as an image acquired under the laser condition A. The control device 112 may determine a mean value of the signal 1B and the signal 2B as an image acquired under the laser condition B.

Returning to FIG. 3, the measurement stage will be described below. The measurement stage includes steps S16 to S19. In step S16, the control device 112 measures the target sample under the laser condition A. As described above, under the laser condition A, the sample is not irradiated with laser light.

The control device 112 applies the set voltage V_{EF} to the energy filter 116 in a state where no laser light is used to irradiate. The control device 112 scans a designated region of the sample with the primary beam 252 under a condition designated by the electron beam condition 351. Accordingly, a two-dimensional sample image under the laser condition A is acquired.

Next, in step S17, the control device 112 measures the target sample under the laser condition B. As described above, the laser condition B designates irradiation with the laser light having the wavelength of 350 nm, the intensity of 100 mV, and the P-polarized light.

The control device 112 provides the set voltage V_{EF} to the energy filter 116. The control device 112 scans a designated region of the sample with the primary beam 252 under a condition designated by the electron beam condition 351 while irradiating the sample with laser light under the designated condition. Accordingly, a two-dimensional sample image under the laser condition B is acquired.

As described with reference to FIG. 10, the control device 112 may perform a plurality of measurements (imaging) under each of the laser conditions A and B, or may perform measurements under each of the laser conditions A and B only once.

Next, in step S18, the control device 112 determines a sample potential under the laser condition A based on a detection signal amount under the laser condition A and with reference to the conversion information. Further, the control device 112 determines a sample potential under the laser condition B based on a detection signal amount under the laser condition B and with reference to the conversion information.

The control device 112 calculates a change in sample potential under the laser condition A and the laser condition B. Using the relationship shown in FIG. 8, a value obtained by subtracting a sample potential under the laser condition B from a sample potential under the laser condition A is calculated. The control device 112 may calculate a difference between a detection signal amount under the laser condition A and a detection signal amount under the laser condition B, and determine a change in potential between the two laser conditions based on the difference and the conversion information. The difference in the detection signal amounts and the changes in potential between the condition A and the condition B are comparison signals representing comparison results of the detection signal amounts under the conditions.

Next, in step S19, the control device 112 calculates a film quality according to the calculation method designated by the measurement condition 352 shown in FIG. 9, and outputs a result. In this example, the control device 112 subtracts the sample potential under the laser condition B from the sample potential under the laser condition A according to the measurement condition designated on the setting screen, and outputs the difference to the output device 124 as information indicating the film quality of the insulating film.

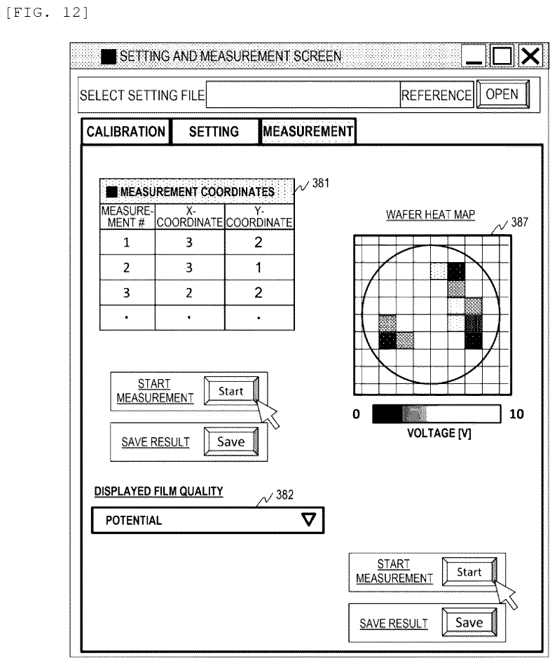

FIG. 11 shows an example of a GUI screen for the measurement stage. The user can designate coordinates 381 to be measured on the screen. The designated coordinates may be, for example, a reference position in a predetermined scanning region or a position of a point to be irradiated with the primary beam.

The user can designate a film quality 382 to be displayed. In the example shown in FIG. 11, a voltage of the sample is designated. For example, the charge amount of the insulating film calculated as described above is displayed. The charge amount is an example of a numerical value indicating a change in sample potential. The control device 112 may hold reference information for calculating the film quality in another unit designated from the calculated sample potential. Accordingly, the film quality can be displayed in units selected from a plurality of options.

The measurement GUI screen further shows a measurement result of the sample. In the example in FIG. 11, an SEM image 383 as a comparison target is displayed in addition to a film quality image 384 of the sample. Accordingly, the user can visually recognize the film quality of the target sample in comparison with a structure. A measurement region of the sample includes, for example, a silicon line 391 and an insulating film 392 deposited on silicon of a trench portion between the silicon lines 391.

In the example in FIG. 11, the film quality image 384 indicates a distribution of a difference between the sample potential under the laser condition A and a sample potential under the laser condition B in the measurement region. The film quality image 384 indicates that the charge amount in the insulating film 392 varies depending on a distance from the silicon. The charge amount represents a film quality of the insulating film 392.

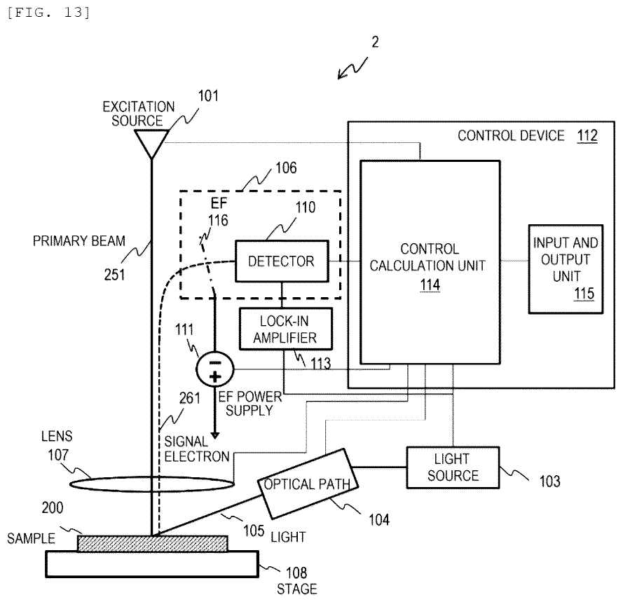

FIG. 12 shows another example of a GUI screen for the measurement stage. Compared with the GUI screen example shown in FIG. 11, displayed measurement results are different. The GUI screen in FIG. 12 shows a wafer heat map 387 as a measurement result. When the measurement is at one location (for example, one pixel) rather than a plurality of locations as in the SEM image, each measurement result indicates one value. The control device 112 can measure a distribution of this value on the sample, and create and display the wafer heat map 387, which is a heat map of a film quality on a wafer. In the present embodiment, when an electron beam current in the condition setting of S15 is large, charge on the insulating film is saturated, and a measured charge amount means a withstand voltage of the insulating film. That is, the withstand voltage can also be measured in the same manner.

### Embodiment 2

Hereinafter, an SEM according to Embodiment 2 in the present description will be described. Hereinafter, differences from the Embodiment 1 will be mainly described. FIG. 13 shows a device configuration example of an SEM 2 equipped with a lock-in detection mechanism. By using the lock-in detection mechanism, measurement sensitivity can be improved.

The SEM 2 includes a lock-in amplifier 113 in addition to the components of the SEM 1 shown in FIG. 1. The control device 112 modulates an intensity of the light source 103 at a constant period, and provides a reference signal of the same period to the lock-in amplifier 113. The lock-in amplifier 113 enables highly accurate detection by the detector 110 that is modulated in synchronization with this period.

For example, as in the example shown in FIG. 9, when the calculation designated in the measurement condition 352 is to calculate a difference between the detection signals acquired under two laser conditions, lock-in detection is particularly effective. The lock-in detection allows for more accurate and faster measurement than if the control device 112 performs subtraction.

### Embodiment 3

Hereinafter, processing of the SEM according to Embodiment 3 in the present description will be described. Hereinafter, differences from the Embodiment 1 will be mainly described. A configuration of the SEM according to the present embodiment may be the same as that of Embodiment 1. In Embodiment 1, the charge amount or the withstand voltage of the insulating film is presented to the user as a physical quantity (material characteristic value) representing the film quality. In the present embodiment, the control device 112 uses a user input to measure and presents a defect density, which is an example of another physical quantity representing the film quality. The present embodiment enables accurate defect density measurement.

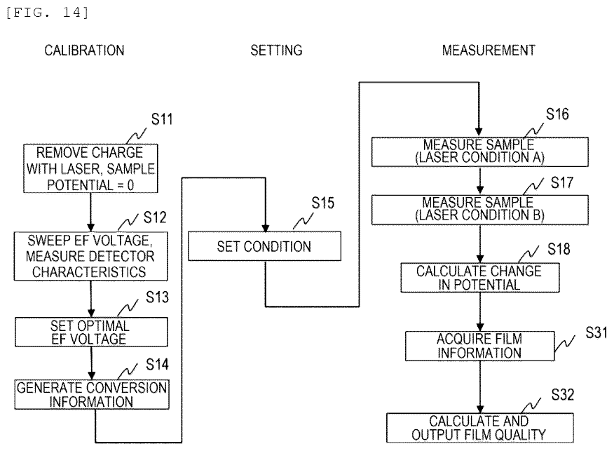

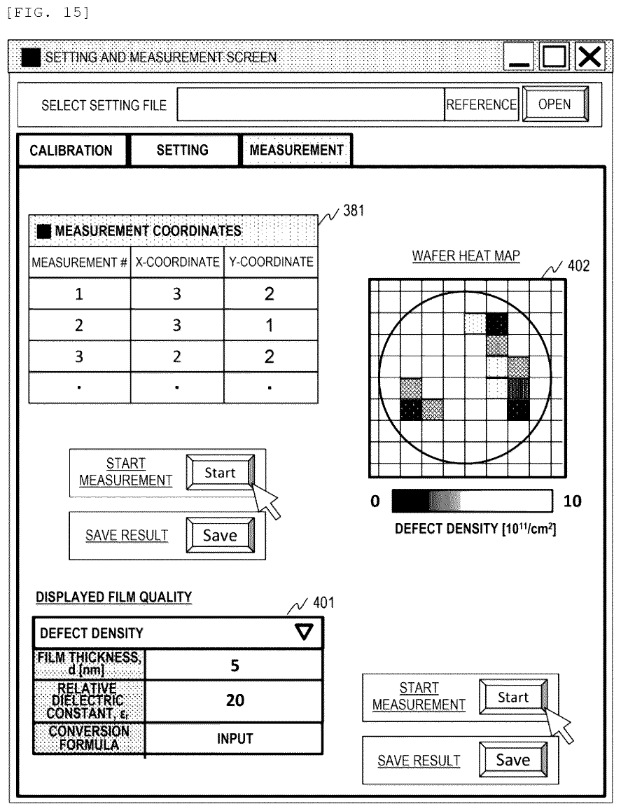

FIG. 14 is a flowchart of an example of control processing of the SEM 1 executed by the control device 112 according to the present embodiment. Steps S11 to S18 are similar as steps S11 to S18 in the flowchart in FIG. 3 according to Embodiment 1.

In step S31, the control device 112 acquires information (film information) on a measurement target film that is input in advance by a user. The film information is stored in, for example, the auxiliary storage device 123. When the measurement target is a film quality of an insulating film, the film information may include, for example, a film thickness and a dielectric constant.

Next, in step S32, the control device 112 calculates a film quality of the measurement target, here, a defect density, based on a comparison result of the sample potential (detection signal amount) under different laser conditions and film information, and outputs the calculated defect density to the output device 124. The control device 112 can calculate the defect density using a preset film quality conversion formula. A conversion formula of the defect density can be expressed as follows.

$$Defect density [ 1 / {cm}^{2} ] = C ( {ε}_{r} , d , V ) \times V \qquad ( conversion formula 1 )$$

C is a function indicating capacitance, and is a function of the relative dielectric constant εᵣ, the film thickness d, and the voltage V. V is a sample potential difference between the laser condition A and the laser condition B, and is obtained by measurement. In a model assuming that charges are uniformly accumulated in the insulating film, a conversion formula including the function C is expressed as follows.

$$Defect density [ 1 / {cm}^{2} ] = 2 \times ( {ε}_{r} \times {ε}_{0} \times V ) / d \qquad ( conversion formula 2 )$$

The control device 112 converts the comparison result of the measured sample potential into a film quality value of the defect density based on film information and a conversion formula input by the user and outputs the film quality value. In the above example, the film information includes the relative dielectric constant Er and the film thickness d of the measurement target insulating film.

FIG. 15 shows an example of a GUI screen in the measurement stage. The user can input information necessary for measuring a desired film quality on the GUI screen. Specifically, it is possible to input information about a measurement target film and a conversion formula for calculating a desired physical quantity representing the film quality. The GUI screen presents a measurement result of a film quality of a sample to the user.

In the example of the measurement GUI screen in FIG. 15, the user designates information 401 on the film quality to be measured and displayed in addition to the measurement coordinates 381. The information 401 on the film quality designates a physical quantity to be measured and displayed, film information, and a conversion formula for calculating the physical quantity. In the example in FIG. 15, a defect density (density of material defects) is selected as the physical quantity representing the film quality. The film information indicates the film thickness and the relative dielectric constant. The user can input a conversion formula into a conversion formula cell. If a simple assumption is made as in the conversion formula 2, the control device 112 holds the conversion formula as default information, and the user may select the conversion formula.

The measurement GUI screen displays a wafer heat map 402 to the user as a measurement result. The wafer heat map 402 is a map showing a relationship between a position on a wafer and a measured defect density. The wafer heat map 402 can be created in the same manner as the wafer heat map 387 shown in FIG. 12. A film quality image showing a defect density may be generated and displayed, such as in the film quality image 384 shown in FIG. 11.

### Embodiment 4

Hereinafter, processing of the SEM according to Embodiment 4 in the present description will be described. Hereinafter, differences from the Embodiment 1 will be mainly described. A configuration of the SEM according to the present embodiment may be the same as that of Embodiment 1. In the present embodiment, the control device 112 measures and presents a defect level and an energy level of a band, which are examples of a physical quantity representing a film quality of an insulating film. Here, measurement of the energy level of the band will be described, and the same can be done for measuring the defect level. The present embodiment enables accurate energy level measurement.

The control device 112 measures the energy level (film quality) based on dependence of a voltage of an insulating film on a light wavelength. To measure the energy level, it is necessary to measure a voltage of an insulating film at a plurality of wavelengths. One example of measuring an energy level of an n important band in a semiconductor device is measuring an energy level difference between a valence band of a semiconductor and a conduction band of an insulating film. This energy level difference can be measured by measuring energy required to inject electrons in the semiconductor into the insulating film. The electrons in the semiconductor are excited by absorbing light to gain energy equivalent to photon energy.

If the photon energy is higher than the energy level difference, electrons in the semiconductor can be injected into the insulating film. If the photon energy is lower than the energy level difference, the photon energy is not injected into the insulating film. When the insulating film is charged, the electrons injected from the semiconductor contribute to removing charge of the insulating film. That is, a standard energy difference can be calculated by measuring a wavelength of light having photon energy capable of removing the charge of the insulating film. In other words, the energy level is calculated based on a relationship between a voltage of the insulating film and a wavelength (photon energy) of emitted light. The control device 112 may control the laser light source 103 so that the number of photons per unit time is the same between wavelengths. The number of photons per second is a value obtained by dividing laser energy by photon energy per second.

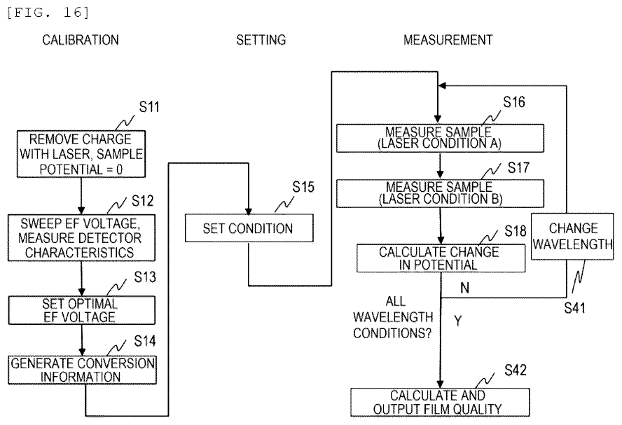

FIG. 16 is a flowchart of an example of control processing of the SEM 1 executed by a control device 112 according to the present embodiment. Steps S11 to S18 are similar as steps S11 to S18 in the flowchart in FIG. 3 according to Embodiment 1.

The control device 112 changes either or both of wavelengths of the laser light emitted to the sample set under the laser condition A and the laser condition B (S41), and repeats a loop of steps S16 to S18 with different laser light wavelengths. For example, the wavelength of the laser condition B in FIG. 10 is changed. Thereafter, in step S42, the control device 112 determines the energy level based on a measurement result of a relationship between a sample potential and a photon energy. Photon energy at which the sample potential largely changes determines the energy level difference.

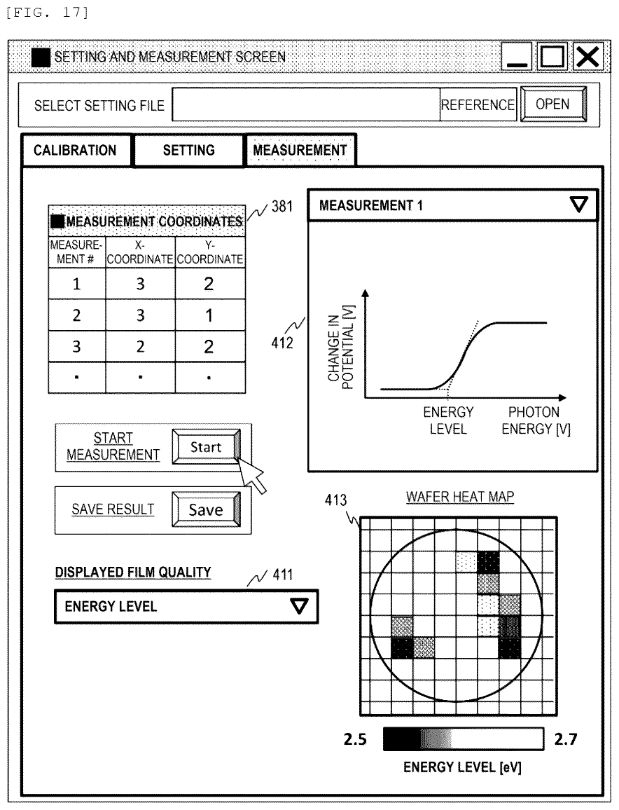

FIG. 17 shows an example of a GUI screen in the measurement stage. The user can input information necessary for measuring a desired film quality on the measurement GUI screen. In this example, the energy level is selected as a physical quantity to display the film quality. The measurement GUI screen further presents a measurement result of a film quality of a sample to the user.

In the example of the measurement GUI screen in FIG. 17, the user designates film quality information 411 to be displayed in addition to the measurement coordinates 381. The film quality information 411 designates the energy level as a physical quantity representing the film quality.

The measurement GUI screen shows a graph 412 showing a relationship between photon energy and a change in sample potential between the condition A and the condition B as a measurement result. In graph 412, a horizontal axis represents photon energy, and a vertical axis represents a sample voltage. In a low photon energy region, charge of the insulating film is not removed, and the sample potential is the same under the laser condition A and the laser condition B, so the change in sample potential is low and approximately constant. Since sample potentials measured under the laser condition A and the laser condition B are different depending on occurrence of charge removing at specific photon energy, the change in sample potential begins to increase. The change in sample potential is substantially constant as a charge removing effect becomes saturated, in a high photon energy region.

The control device 112 may determine, as the energy level of the sample, a point at which the sample voltage changes most with respect to a change in photon energy, that is, an intersection of a tangent to a point at which an absolute value of a differential is the largest and an approximate straight line in the low photon energy region.

The measurement GUI screen further displays a wafer heat map 413 to the user. The wafer heat map 413 is a map showing a relationship between a position on a wafer and a measured energy level. The wafer heat map 413 can be created in the same manner as the wafer heat map 387 shown in FIG. 12. A film quality image showing an energy level may be generated and displayed, such as in the film quality image 384 shown in FIG. 11.

In the present embodiment, an energy level difference between the semiconductor and the insulating film is measured. On the other hand, for example, if an energy level of a semiconductor is known as an absolute value, an energy level of the insulating film can be obtained using a measured energy level difference. When there is a trap at the insulating film or at an interface thereof, electrons held in the trap can be excited by light, and a trap level can be obtained based on a relationship between a change amount of sample potential and photon energy in the same manner as a band energy level difference between the semiconductor and the insulating film.

### Embodiment 5

Hereinafter, processing of the SEM according to Embodiment 5 in the present description will be described. Hereinafter, differences from the Embodiment 1 will be mainly described. A configuration of the SEM according to the present embodiment may be the same as that of Embodiment 1. In the present embodiment, the control device 112 measures and presents a carrier lifetime or mobility, which is an example of a physical quantity representing the film quality. The present embodiment enables accurate measurement of carrier lifetime and mobility.

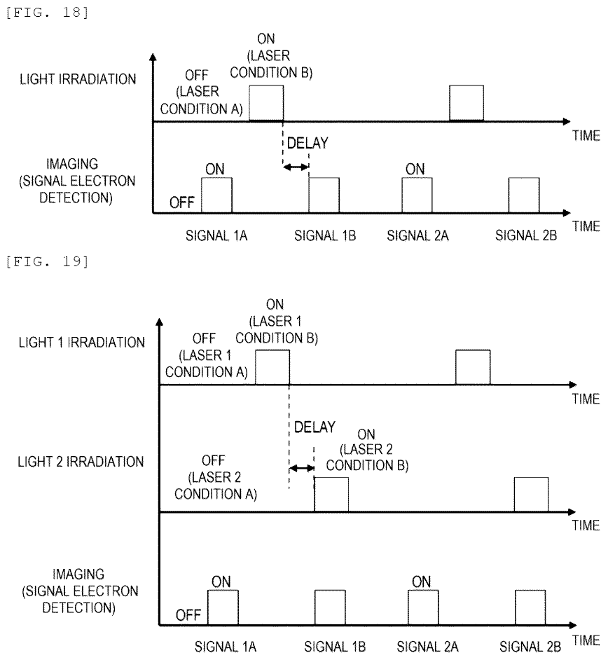

The control device 112 measures the carrier lifetime and the mobility based on a time difference between pulsed light irradiation and pulsed electron beam (primary beam) irradiation. The carrier lifetime and mobility appear in a transient response of the measurement. For example, FIG. 18 shows an example of a sequence of laser light irradiation to a sample and imaging (primary beam irradiation) of the sample.

In the example shown in FIG. 18, the control device 112 captures an image of the sample with the laser turned off (laser condition A), and acquires the signal 1A. Next, after performing irradiation with the laser light (laser condition B), the control device 112 captures an image of the sample after a predetermined waiting time (DELAY) and acquires the signal 1B. In one measurement, the signal 1A and the signal 1B are acquired. Thereafter, the signals 2A and 2B are acquired by measurement at different waiting times. Hereinafter, measurement is repeated at different waiting times.

In the example shown in FIG. 18, instead of acquiring the signal 1B from simultaneous irradiation with the laser light and the electron beam (primary beam), the control device 112 provides a time difference (DELAY) between the laser light irradiation and the electron beam irradiation. By controlling a length of the waiting time and measuring dependence of a measured potential change on the waiting time, the control device 112 can measure a response of the insulating film and the interface thereof to light.

The control device 112 uses a conversion formula to convert a response characteristic into the carrier lifetime and the mobility. This conversion formula takes the waiting time into account. For example, the carrier lifetime and the mobility can be calculated using a conversion formula based on a waiting time indicating a large change in sample potential.

In a case of a phenomenon in which the change in sample potential according to a plurality of types of light irradiation, as shown in FIG. 19, the control device 112 sets the waiting times for a plurality of types of light irradiation as variable parameters. FIG. 19 shows an example of a sequence of laser light irradiation to the sample and imaging (primary beam irradiation) of the sample.

In the example shown in FIG. 19, the control device 112 captures an image of the sample without irradiating the sample with laser light (laser 1 condition A and laser 2 condition A), and acquires the signal 1A. Next, after performing irradiation with the laser light 1 (laser 1 condition B), the control device 112 captures an image of the sample while performing irradiation with laser light 2 (laser 2 condition B) after a predetermined second waiting time (DELAY), and acquires the signal 1B. In one measurement, the signal 1A and the signal 1B are acquired. Thereafter, the signals 2A and 2B are acquired by measurement at different waiting times. Hereinafter, measurement is repeated at different waiting times.

The laser light 1 and the laser light 2 have different wavelengths, for example. The control device 112 can calculate and output a response characteristic of the phenomenon based on a relationship between the change in sample potential and the waiting time. The waiting time (time difference) can be input on the measurement GUI screen as a set value by the user. The control device 112 can display a graph in which a horizontal axis indicates the waiting time and a vertical axis indicates the change in sample potential as the measurement result. A heat map or a film quality image showing the carrier lifetime and the mobility may be generated and displayed.

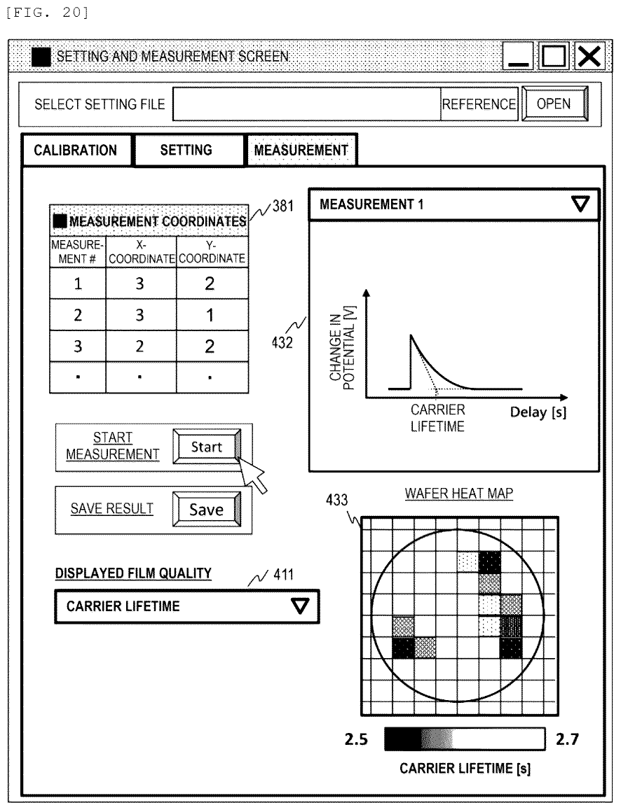

FIG. 20 shows an example of a GUI screen in the measurement stage. The user can input information necessary for measuring a desired film quality on the measurement GUI screen. In this example, the carrier lifetime is selected as a physical quantity to display the film quality. The measurement GUI screen further presents a measurement result of a film quality of a sample to the user.

In the example of the measurement GUI screen in FIG. 20, the user designates film quality information 411 to be displayed in addition to the measurement coordinates 381. The film quality information 411 designates the carrier lifetime as a physical quantity representing the film quality.

The measurement GUI screen shows a graph 432 showing a relationship between a waiting time and a change in sample potential between the condition A and the condition B as a measurement result. In graph 432, a horizontal axis represents a waiting time, and a vertical axis represents a sample voltage. The control device 112 may determine, as the carrier lifetime of the sample, a point at which the sample voltage changes most with respect to a change in waiting time, that is, an intersection of a tangent to a point at which an absolute value of a differential is largest and an approximate straight line in a region of a large waiting time.

The measurement GUI screen further displays a wafer heat map 433 to the user. The wafer heat map 433 is a map showing a relationship between a position on a wafer and a measured carrier lifetime. The wafer heat map 413 can be created in the same manner as the wafer heat map 387 shown in FIG. 12. A film quality image showing a carrier lifetime may be generated and displayed, such as in the film quality image 384 shown in FIG. 11.

The invention is not limited to the embodiments described above, and includes various modifications. For example, the embodiments described above have been described in detail to facilitate understanding of the invention, and the invention is not necessarily limited to those including all the configurations described above. A part of a configuration of a certain embodiment can be replaced with a configuration of another embodiment, and the configuration of another embodiment can be added to the configuration of a certain embodiment. A part of a configuration in each embodiment may be added to, deleted from, or replaced with another configuration.

Some or all of the configurations, functions, processing units, and the like described above may be implemented by hardware by, for example, designing with an integrated circuit. The above configurations, functions, and the like may be implemented by software by a processor interpreting and executing a program for implementing each function. Information such as a program, a table, and a file for implementing each function can be stored in a recording apparatus such as a memory, a hard disk, or a solid state drive (SSD), or in a recording medium such as an IC card or an SD card.

Control lines and information lines are those considered to be necessary for description, and not all the control lines and information lines are necessarily shown in the product. Actually, it may be considered that almost all the configurations are connected to one another.

1. A sample measurement device comprising:
a light source configured to irradiate a sample including an insulating film with light;
an excitation source configured to irradiate the sample with a primary beam to emit a charged particle;
a detector configured to apply at least one of an electric field or a magnetic field to the charged particle to separate a trajectory according to energy of the charged particle, thereby outputting a detection signal depending on the energy of the charged particle;
a control device configured to process a detection signal of the charged particle obtained from the detector; and
an input device configured to input information related to the sample from a user, wherein
the control device
determines a change in potential of the sample under different irradiation conditions based on detection signals detected by the detector under the different irradiation conditions of the light and information indicating a relationship between the detection signal and a potential of the sample, and
converts the change in potential into a material characteristic value of the insulating film using a film thickness and a dielectric constant in information related to the sample, and outputs the converted material characteristic value.

2. The sample measurement device according to claim 1, wherein
the material characteristic value includes at least one of a withstand voltage, a defect density, carrier mobility, a carrier lifetime, a defect level, and band energy for the insulating film.

3. The sample measurement device according to claim 2, wherein
the control device measures and outputs a distribution of the material characteristic value on the sample by two-dimensionally scanning a position where the charged particle is emitted on the sample.

4. The sample measurement device according to claim 1, wherein
the control device uses lock-in detection to perform detection by the detector under different irradiation conditions of the light.

5. The sample measurement device according to claim 1, wherein
the control device irradiates the sample with ultraviolet light having a wavelength of 400 nm or less to calibrate the detector.

6. A sample measurement device comprising:
a light source configured to irradiate a sample including an insulating film with light having a plurality of wavelengths;
an excitation source configured to irradiate the sample with a primary beam to emit a charged particle;
a detector configured to apply at least one of an electric field or a magnetic field to the charged particle to separate a trajectory according to energy of the charged particle, thereby outputting a detection signal depending on the energy of the charged particle; and
a control device configured to process a detection signal of the charged particle obtained from the detector, wherein
the control device
generates a comparison signal indicating a comparison result of detection signals detected by the detector under different irradiation conditions of the light, for each of different wavelengths of the light, and
outputs information on the film quality of the insulating film based on the comparison signal.

7. The sample measurement device according to claim 6, wherein
the control device determines a material characteristic value corresponding to the comparison signal using information indicating a relationship between wavelength dependency of the comparison signal and a material characteristic value of the insulating film, and outputs the determined material characteristic value.

8. The sample measurement device according to claim 7, wherein
the material characteristic value includes at least one of a withstand voltage, a defect density, carrier mobility, a carrier lifetime, a defect level, and band energy for the insulating film.

9. The sample measurement device according to claim 6, wherein
the control device uses lock-in detection to perform detection by the detector under different irradiation conditions of the light.

10. The sample measurement device according to claim 6, wherein
the control device irradiates the sample with ultraviolet light having a wavelength of 400 nm or less to calibrate the detector.

11. The sample measurement device according to claim 6, wherein
the control device
irradiates the sample with pulsed light and pulsed primary beam at a first time difference, and
determines a material characteristic value of the insulating film based on dependency of the comparison signal on the first time difference.

12. The sample measurement device according to claim 6, wherein
the control device
irradiates the sample with a first light pulse and a second light pulse at a second time difference with respect to the first light pulse, and
determines a material characteristic value of the insulating film based on dependency of the comparison signal on the second time difference.

13. A sample measurement device comprising:
a light source configured to irradiate a sample including an insulating film with light;
an excitation source configured to irradiate the sample with a primary beam to emit a charged particle;
a detector configured to apply at least one of an electric field or a magnetic field to the charged particle to separate a trajectory according to energy of the charged particle, thereby outputting a detection signal depending on the energy of the charged particle; and
a control device configured to process a detection signal of the charged particle obtained from the detector, wherein
the control device
changes a light irradiation condition, and acquires detection signals by the detector under different irradiation conditions, and
determines a material characteristic value of the insulating film based on the detection signals under the different irradiation conditions using information indicating a relationship between the detection signal and the material characteristic value, and outputs the material characteristic value.

14. The sample measurement device according to claim 13, wherein
the different irradiation conditions are different in wavelength of the light with which the sample is irradiated.
